(19) United States
(12) Patent Application Publication
(10) Pub. No.: US 2003/0171453 A1
(43) Pub. Date: Sep. 11, 2003

(54) Erasable Inks

(76) Inventor: Jie Li, Allentown, PA (US)

Correspondence Address: FISH & RICHARDSON PC, 225 FRANKLIN ST, BOSTON, MA, 02110, US

(21) Appl. No.: 10/093,666

(22) Filed: Mar. 8, 2002

(51) Int. Cl. C03C 17/00; C09D 5/00

(52) U.S. Cl. 523/160; 523/161

(57) ABSTRACT

Erasable ink compositions are provided, including water, a coloring agent, a releasing agent including an alkoxylated siloxane, and a film-forming binder. In another aspect, erasable ink compositions are provided including a releasing agent having a water solubility ranging from about 0.5 to about 60%. The erasable inks are suitable for use on marker boards, e.g., white boards.

### TECHNICAL FIELD

This invention relates to erasable inks suitable for use on marker boards.

### BACKGROUND

Marker boards, commonly referred to as “white boards,” are writing boards that are designed to be written on with a marking pen and erased using, for example, a tissue, soft cloth, or dry eraser (i.e., a cloth eraser similar to the erasers used to erase chalk from blackboards). Marker boards are typically made of ceramic or plastic, and have a smooth, hard, glossy surface. Often, marker boards are used to replace blackboards, due to the dusty, messy nature of chalk and the cumbersome weight of blackboards.

It is desirable that erasable inks for use with marker boards dry relatively quickly, and that the dried ink be easily erasable with a tissue, soft cloth or dry eraser. It is also desirable that the ink not stain the board and leave minimal residue on the board after erasing. Because some users will try to erase the ink almost immediately after making a marking, it is desirable that the ink be erasable shortly after it has been applied to the board. It is also desirable that the applied ink mark remain erasable for a long period of time because such marks are commonly left on marker boards for weeks at a time.

Water-based inks are desirable for use with marking boards because such inks can be formulated to be relatively non-toxic and low-odor, unlike most inks containing organic solvents. However, water-based inks tend to take longer to dry than solvent-based inks and are generally difficult to erase without smearing until the ink has dried. As a result, solvent-based inks are still commonly used, despite their safety and environmental drawbacks.

### SUMMARY

The invention features water-based marker board inks that have a short “waiting time”, i.e., inks that can be erased soon after they are applied to the marker board. Because the inks have a short “waiting time”, a marking can be made on the marker board and then quickly erased without smearing. This feature enhances the user-friendliness of markers containing water-based inks by minimizing delay and frustration and may contribute to more widespread consumer acceptance of such markers.

Because they are water-based rather than solvent-based, the inks of the invention are relatively non-toxic and odor-free. The inks are also safer to manufacture, ship and store than solvent-based inks.

In one aspect, the invention features an erasable ink composition that includes (a) water, (b) a coloring agent, (c) a releasing agent including an alkoxylated siloxane, and (d) a film-forming polymeric binder.

Some implementations include one or more of the following features. The water is present in an amount ranging from about 40 to about 90% by weight. The coloring agent is present in an amount ranging from about 0.2 to about 30% by weight. The releasing agent is present in an amount ranging from about 0.3 to about 30% by weight. The polymeric binder is present in an amount ranging from about 1 to about 15% by weight. The polymeric binder includes a polyvinyl butyral resin. The polymeric binder includes a plasticized polyvinyl butyral resin. The releasing agent has a water solubility ranging from about 0.5 to about 60%. The siloxane resin is modified with propoxy and/or ethoxy groups. The siloxane resin includes a polyalkyleneoxide modified poly(dialkyl)siloxane resin, e.g., a polyethylene oxide modified poly(dimethyl)siloxane resin. The composition contains less than 1% colloidal silica. The composition has a viscosity of less than 30 cps at 25□C. The composition is a newtonian fluid.

In another aspect, the invention features an erasable ink composition that includes (a) water, (b) a coloring agent, (c) a releasing agent including an alkoxylated siloxane, and, (d) a film-forming polymeric binder. In a preferred embodiment, the composition is substantially free of colloidal silica particles.

In a further aspect, the invention features an erasable ink composition including (a) water, (b) a coloring agent, (c) a releasing agent comprising a siloxane resin modified with alkoxy groups, and (d) a film-forming polymeric binder.

In yet another aspect, the invention features an erasable ink composition including (a) 40-90% by weight water, (b) 0.5 to 30% by weight of a coloring agent, (c) 0.3-30% by weight of a releasing agent comprising a siloxane resin having a water solubility ranging from about 0.5 to about 60%, and (d) 1-15% by weight of a film-forming polymeric binder comprising a polyvinyl butyral resin.

In some implementations, the erasable ink composition includes one or more of the following features. The erasable ink composition is erasable from a marking board without smearing 30 seconds after the ink is applied to the marking board. The erasable ink has an erasability of greater than 90% when wiped within 30 seconds of applying the ink to the marking board.

The invention also features methods of using the erasable inks of the invention. For example, the invention features a method of writing on a marking board including (a) providing an erasable ink of the invention, and (b) making a mark with the ink on a marking board having a smooth, substantially non-porous surface.

Some implementations include one or more of the following features. The ink is provided in a marker. The method further includes erasing the mark. The erasing step is performed within 30 seconds after the mark is made. The mark is erased using a dry eraser. The mark remains erasable for at least two months. The marking board is a plastic board.

In a further aspect, the invention features pens for marking boards containing inks of the invention. For example, the invention features a pen for marking boards that includes an outer body, a writing tip at one end of the body, a reservoir included within the body and connected to the writing tip, and within the reservoir an aqueous erasable ink of the invention, the ink having the ability to form markings on a smooth, substantially non-porous surface, the markings being erasable from the surface by a dry eraser.

The term “erasable ink” as used herein, means an ink that can be removed from a smooth, substantially nonporous marker board, such as a melamine board, after the ink has fully dried, using a soft cloth, paper, or dry eraser, with minimal residue and staining remaining on the board after erasing.

The details of one or more embodiments of the invention are set forth in the accompanying drawings and the description below. Other features and advantages of the invention will be apparent from the description and drawings, and from the claims.

### DETAILED DESCRIPTION

Preferred erasable inks include a coloring agent, a releasing agent, a film-forming polymeric binder and water.

The coloring agent provides the ink with the desired color. Enough coloring agent should be included in the ink to provide the desired color intensity. Preferred inks contain from about 0.2 to 30% by weight of the coloring agent, on a solids basis, more preferably about 1 to 5% by weight. Preferably, the coloring agent includes a pigment or dye. Suitable pigments include water dispersible pigments, which are typically provided in the form of aqueous pigment dispersions. Such pigments are commercially available, e.g., from Hoechst Celanese under the tradenames FLEXONYL and HOSTAFINE; from KVK USA Inc. under the tradename PREDISOL; from Heucotech Ltd. under the tradename HEUCOSPERSE; from Nippon Keiko Kaguka, Ltd., under the tradename LUMIKOL, and from Mikuni Color Works, Inc., under the tradename TITICACA. The total amount of the pigment dispersion to be added will depend upon the solids level of the dispersion.

The releasing agent allows the ink to be erased from a marker board. Suitable releasing agents include siloxanes that have been modified to include alkoxy groups, generally by capping the siloxane at each end with alkylene oxide (CH2CH2O) units. This modification renders the siloxane partially water soluble, such that the modified siloxanes have a water solubility within the range discussed above. Increased degrees of alkoxylation provide greater water solubility due to the polar nature of the alkoxy groups, and thus greater water compatibility.

One suitable modified siloxane is a polyalkyleneoxide modified heptamethyltrisiloxane manufactured by Setre Chemical Company, Memphis, Tenn. and commercially available under the tradename Silwet L-77. This siloxane has a water solubility of about 20%. The Silwet L-77 siloxane also includes an allyloxypolyethyleneglycol methyl ether. Other alkoxylated siloxanes from Setre Chemical Company also perform well. These include Silwet L-7607, L-7608, L-7622, L7604 and L-7602 siloxanes.

To enhance erasability, the releasing agent may have a water solubility ranging from about 0.5 to 100%, preferably from about 0.5 to 70%. The solubility range is selected to allow the release agent to quickly phase separate from the film-forming binder and coloring agent after the ink is applied to a surface. During this phase separation, the release agent forms a bottom layer that contacts the marker board and the film-forming binder and coloring agent form a top layer. The rapid separation of the coloring agent and binder from the releasing agent tends to enhance the ability of the ink to be cleanly erased from the board before the ink has fully dried.

Preferably, the inks contain from about 0.3 to 30% by weight of the releasing agent, more preferably from about 1 to 7% by weight. If the ink contains too much of the releasing agent, the ink may smear, whereas if the ink contains too little of the releasing agent erasability may be compromised.

Water solubilized mineral oil, e.g., in an amount of 0 to 1%, may be used as an additional releasing agent to enhance the wiping smoothness of the ink.

The film-forming binder allows the ink to form a film on a smooth surface, such as the surface of a marker board, so that the ink will form smooth, continuous markings on the surface. The properties of the film-forming binder also affect the erasability of the ink. It is preferred that the film-forming binder be capable of forming a relatively soft, flexible film. A soft film generally erases more easily, with less color staining, than a tougher film. A soft film can be provided, for example, by using a relatively strong film-forming binder in combination with a plasticizer.

Suitable binders include polyvinyl acetal polymers, poly(vinyl alcohol), styrene-butadiene rubber, polyurethane, and acrylic resins, and in particular polyvinyl butyral copolymers. Emulsified polyvinyl butyral is generally preferred. For example, a suitable binder is a terpolymer of polyvinyl butyral, polyvinyl alcohol and polyvinyl acetate that is commercially available from Solutia, Inc., St. Louis, Mo., under the tradename BUTVAR BR. This binder is an aqueous dispersion containing about 34% by weight of the terpolymer, 49% by weight water, 15% by weight of butyl ricinoleate (a soap) and 2% by weight of potassium oleate (another soap).

Generally, it is preferred that the inks contain from about 1 to 15% by weight of the binder, on a solids basis, more preferably from about 3 to 10% by weight. If too much binder is used, the mark may be difficult to erase, while if too little binder is used a stain may remain on the writing surface.

As noted above, to satisfy both staining and ease of erasure, a soft film-forming resin is desired. Therefore, it may be necessary to include a plasticizer in the ink composition, to plasticize the binder. Suitable plasticizers can be selected based on the properties of the binder used and the desired final softness of the film-forming resin. For example, suitable plasticizers for the polyvinyl butyral terpolymer discussed above include adipate ester plasticizers, e.g., a di(C7-C9-alkyl)adipate commercially available from Solutia, Inc. under the tradename SANTICIZER 97.

If a plasticizer is included, it is used in a sufficient quantity to obtain the desired film properties in the ink composition. Suitable amounts generally range from about 5 to 15% by weight on a solids basis. If too much plasticizer is used, the film may be overly soft and smear, while if too little plasticizer is used with a relatively hard binder the film may be too hard and erasability may be compromised.

The ink may optionally include a secondary releasing agent, e.g., mineral oil, that enhances erasabilty and wetting of the writing surface. The secondary releasing agent may be provided in an amount of, e.g., from 0.2 to 1%.

Water is used as a solvent, to reduce the viscosity of the inks and disperse the other ingredients. Preferably, a sufficient amount of water is included so that the inks have a Brookfield viscosity of less than about 12 cps at 25□C. Some water is contributed by the pigment and binder dispersions. Generally, additional water is added, to provide a total water content of about 40 to 90% by weight. If the ink viscosity is too high, the ink may not be suitable for use in a capillary feed marker having a porous nib, the type of marker that is typically used with marker boards.

The ink compositions can include other ingredients, so long as such ingredients do not result in unacceptable erasability or a viscosity that renders the ink unusable. For example, the compositions may include humectants, antifreeze agents, preservatives, buffers and emulsifiers, as is well known in the ink field. Generally, viscosity or thixotropy increasing ingredients, for example fumed silica, are undesirable. Preferred inks have a short waiting time. Waiting time is measured by making a mark on a writing surface at 70° F. and 50% relative humidity and erasing a portion of the mark every few seconds until no smearing is observed. Preferably the ink compositions have a waiting time of less than about 30 seconds, more preferably less than about 20 seconds.

The percent of the mark erased (% erasability) can be determined by measuring the color intensity of the mark both before and after erasure versus the color intensity of the clean writing surface by the use of a calorimeter.

The ink is suitable for use on whiteboards, glass, metal and plastic surfaces.

Preferred inks can be used in conventional capillary feed markers. Capillary feed markers typically include a fiber tip (or nib) connected to an ink reservoir, which may also be made of a fibrous material. The reservoir is surrounded by a plastic barrel and is capped at the end opposite the nib with a plug. Such markers also include a cap for covering the nib. Ink is drawn from the reservoir to the nib by capillary action.

### EXAMPLE

An ink composition was formed by mixing the ingredients shown in Table 1:

| | | Amount | |
|---|---|---|---|
| Ingredient | Supplier | (Wt %) | Description |
| Water | — | 56.96 | Solvent |
| Butvar BR | Solutia, Inc. | 23.4 | Film-forming resin |
| Santicizer 97 | Solutia, Inc. | 7.8 | Plasticizer |
| Hostafine Blue B2G | Hoechst Celanese | 3.5 | Pigment |
| Ethylene Glycol | — | 2.0 | Antifreeze agent |
| Michem Lube 316 | Michelman, Inc. | 1.0 | Secondary releasing |
| | | | agent |
| Silwet L-77 | Crompton, Corp. | 4.0 | Releasing agent |
| Proxel B2 | Avecia, Inc. | 0.3 | Preservative |
| 20% Na Hydroxide | — | 0.31 | pH Adjuster |
| Solution | | | |
| Priolene 6910 | Unichema | | Emulsifier (oleic acid) |
| | International | | |

The weights of each material given in the table above are based on the composition of the material as received from the manufacturer, and thus include any water that is used as a dispersant in the material.

This ink was applied to a melamine marker board. After 30 seconds, a dry eraser was used to wipe the ink off of the marker board. The ink erased cleanly, leaving no visible residue or staining. A second marking was applied to the board and allowed to dry for a longer period (60 seconds). This marking also erased cleanly. The ink exhibited an erasability of 95% after a waiting time of 10 seconds, and an erasability of 100% when completely dry.

Other embodiments are within the scope of the following claims.

What is claimed is:

1. An erasable ink composition comprising:
(a) water;
(b) a coloring agent;
(c) a releasing agent comprising an alkoxylated siloxane; and
(d) a film-forming polymeric binder.

2. An erasable ink composition according to claim 1 wherein the water is present in an amount ranging from about 40 to about 90% by weight.

3. An erasable ink composition according to claim 1 wherein the coloring agent is present in an amount ranging from about 0.2 to about 30% by weight.

4. An erasable ink composition according to claim 1 wherein the releasing agent is present in an amount ranging from about 0.3 to about 30% by weight.

5. An erasable ink composition according to claim 1 wherein the polymeric binder is present in an amount ranging from about 1 to about 15% by weight.

6. An erasable ink composition according to claim 1 wherein the polymeric binder comprises a polyvinyl butyral resin.

7. An erasable ink composition according to claim 1 wherein the polymeric binder comprises a plasticized polyvinyl butyral resin.

8. An erasable ink composition according to claim 7 wherein the polyvinyl butyral resin is in the form of a water dispersible emulsion.

9. An erasable ink composition according to claim 1 wherein the releasing agent has a water solubility ranging from about 0.5 to about 60%.

10. An erasable ink composition according to claim 9 wherein the siloxane resin is modified with propoxy or ethoxy groups.

11. An erasable ink composition according to claim 10 wherein said siloxane resin comprises a polyalkyleneoxide modified poly(dialkyl)siloxane resin.

12. An erasable ink composition according to claim 11 wherein said poly(dialkyl)siloxane resin comprises a poly(dimethyl)siloxane resin.

13. An erasable ink composition according to claim 1 wherein said composition contains less than 1% colloidal silica.

14. An erasable ink composition according to claim 1 wherein said composition has a viscosity of less than 30 cps at 25□C.

15. An erasable ink composition according to claim 1 wherein said composition is a newtonian fluid.

16. An erasable ink composition comprising:
(a) water;
(b) a coloring agent;
(c) a releasing agent having a water solubility ranging from about 0.5 to about 60%; and
(d) a film-forming polymeric binder.

17. An erasable ink composition according to claim 1 or 16 wherein said composition is substantially free of colloidal silica.

18. An erasable ink composition according to claim 17 wherein said siloxane resin comprises a polyalkyleneoxide modified poly(dialkyl)siloxane resin.

19. An erasable ink composition comprising:
(a) 40-90% by weight water;
(b) 0.2 to 30% by weight of a coloring agent;
(c) 0.3-30% by weight of a releasing agent comprising a siloxane resin having a water solubility ranging from about 0.5 to about 60%; and
(d) 1-15% by weight of a film-forming polymeric binder comprising a polyvinyl butyral resin.

20. An erasable ink composition according to claim 1, 16 or 19 wherein said erasable ink is erasable from a marking board 30 seconds after applying the ink to the marking board.

21. An erasable ink composition according to claim 1, 16 or 19 wherein said erasable ink has an erasability of greater than 90% when wiped within 30 seconds of applying the ink to the marking board.

22. A method of writing on a marking board comprising
providing an ink comprising
(a) water;
(b) a coloring agent;
(c) a releasing agent comprising an alkoxylated siloxane; and
(d) a film-forming polymeric binder; and
making a mark with said ink on a marking board having a smooth, substantially non-porous surface.

23. A method according to claim 22 wherein the releasing agent has a water solubility ranging from about 0.5 to about 60%

24. A method according to claim 22 wherein said ink is provided in a marker.

25. A method according to claim 22 further comprising erasing the mark.

26. A method according to claim 25 wherein the erasing step is performed less than 60 seconds after the mark is made.

27. A method according to claim 25 wherein the mark is erased using a dry eraser.

28. A method according to claim 22 wherein the marking board is a smooth, substantially nonporous board.

29. A method according to claim 28 wherein the board comprises a whiteboard.

30. A method according to claim 28 wherein the mark remains erasable for at least 2 months.

31. A pen for marking boards comprising an outer body, a writing tip at one end of said body, a reservoir included within said body and connected to said writing tip, and within said reservoir an aqueous erasable ink comprising
(a) water;
(b) a coloring agent;
(c) a releasing agent having a water solubility ranging from about 0.5 to about 60%; and
(d) a film-forming polymeric binder;
said ink having the ability to form markings on a smooth, substantially non-porous surface, said markings being erasable from said surface by a dry eraser.

32. A pen according to claim 31 wherein said writing tip comprises a porous nib.
